(19) United States
(12) Patent Application Publication
(10) Pub. No.: US 2003/0068209 A1
(43) Pub. Date: Apr. 10, 2003

(54) Drilling head

(76) Inventors: Erich Leibhard, Munich (DE); Wolfgang Ludwig, Schwabmunchen (DE)

Correspondence Address: SIDLEY AUSTIN BROWN & WOOD LLP, 787 Seventh Avenue, New York, NY, 10019, US

(21) Appl. No.: 10/231,615

(22) Filed: Aug. 29, 2002

(30) Foreign Application Priority Data
Aug. 30, 2001 (DE) 101 42 560.0

(51) Int. Cl. B23B 51/00

(52) U.S. Cl. 408/231

(57) ABSTRACT

A drilling head including a base body (1), a bit (2) securable in a recess (10) formed in the base body (1) at the end of the base body (1) and facing in a drilling direction (B), and guide elements for guiding the base body and the bit relative to each other in a direction transverse to the drilling direction.

### BACKGROUND OF THE INVENTION

1. Field of the Invention

The present invention relates to a drilling head having a base body, a bit securable in the base body at the end of the base body facing in a drilling direction and clamping means for securing the bit in the base body and including two opposite inclination surfaces forming a recess widening in the drilling direction and in which the bit is secured.

2. Description of the Prior Art

Drilling heads of the type described above find application in many fields. They are used as drilling heads of drilling tools, as self-drilling fastening elements, and the like. The base body receives a bit and insures its proper guidance. The bit is used for removing the material during a drilling operation and forms a substantially cylindrical bore, e.g., in a constructional component. The base body also serves for removing drillings. The bit is formed, e.g., as a hard metal plate, whereas the base body is formed of steel. Dependent on an intended use, the bit and the base body can be formed of other materials than those mentioned above, or, additionally, the bit can include diamond particles.

European Publication EP 454 115 B1 discloses a drilling head having a base body, a bit securable in the base body at an end of the base body facing in a drilling direction, and clamping means for securing the bit in the base body. The clamping means including two opposite inclination surfaces forming a recess widening in the drilling direction and in which the bit is secured.

The drawback of a drilling head disclosed in the above-mentioned European Publication consists in that the bit is not adequately guided in the base body and, as a result, the drilling capacity of the drilling head is reduced.

Further, with the drilling head described above, the replacement and positioning of bits in the base body is a time-consuming operation which, therefore, is not economical.

Accordingly, an object of the present invention is to provide a drilling head of the type described above and having a high drilling capacity.

Another object of the present invention is to provide a drilling head in which the bit is easily replaceable.

### SUMMARY OF THE INVENTION

These and other objects of the present invention, which will become apparent hereinafter, are achieved by providing, in a drilling head of the type described above, clamping means that includes guide means for guiding the base body and the bit relative to each other in a direction transverse to the drilling direction.

The guide means prevents, on one hand, displacement of the bit in a direction transverse to the drilling direction and, on the other hand, simplifies the insertion of the bit in the base body. During the drilling process, the bit is pressed into the recess formed by the inclination surfaces under pressure applied to the drilling head for effecting the drilling process. That insures the guidance of the drilling head bit parallel to the drilling direction. Transverse to the drilling direction, the guide means guide means guide the bit relative to the base body. The guidance of the bit in all directions, provides for a high drilling output of the drilling head.

According to the invention, the guide means includes a groove formed in the base body or the bit and a web extending in the drilling direction, complementary to the groove, and provided on another of the base body and the bit.

The formation of the guide means as a groove and a web insures economical manufacturing of the drilling head.

Advantageously the groove is arranged, in a direction transverse to the drilling direction somewhat in a middle between edge regions likewise extending in the direction opposite the drilling direction. This arrangement of the groove insures an optimal distribution of the load which acts , during the drilling process on the base body and, in particular, on the guide means and the recess-forming inclination surfaces. The symmetrical, with respect to the drilling head axis, arrangement of the groove further insures a uniform load distribution for driving the drilling head.

To insure a reliable connection of the bit with the base body, the recess-forming inclination surfaces and further surfaces, which cooperate with the recess-forming surfaces, form, in the direction opposite the drilling direction, an angle from 1.5° to 4° which opens in the drilling direction.

The recess-forming and further inclination have, in the direction transverse to the drilling direction, a width corresponding to from 0.1 to 0.2 of a width of the bit measured in the direction transverse to the drilling direction.

When the drilling head is used, e.g., as a suction drilling head or as a self-drilling fastening element, advantageously, at least the drilling direction region of the base body has a sleeve shape to provide a channel for removal of material. The material consists of air with dispersed therein drillings and mortar mass.

Advantageously, the groove is formed by the inner wall of the base body, which also insures an economical manufacturing of the drilling head.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a side view of a sleeve-shaped drilling head;

FIG. 2 a side view of the drilling head shown in FIG. 1 and pivoted by 90° about its longitudinal axis;

FIG. 3 top view of the drilling head shown in FIGS. 1-2;

FIG. 4 a perspective view of a base body of another embodiment of a drilling head according to the present invention; and

FIG. 5 a perspective view of a bit for the base body shown in FIG. 4

### DETAILED DESCRIPTION OF THE PREFERRED EMBODIMENTS

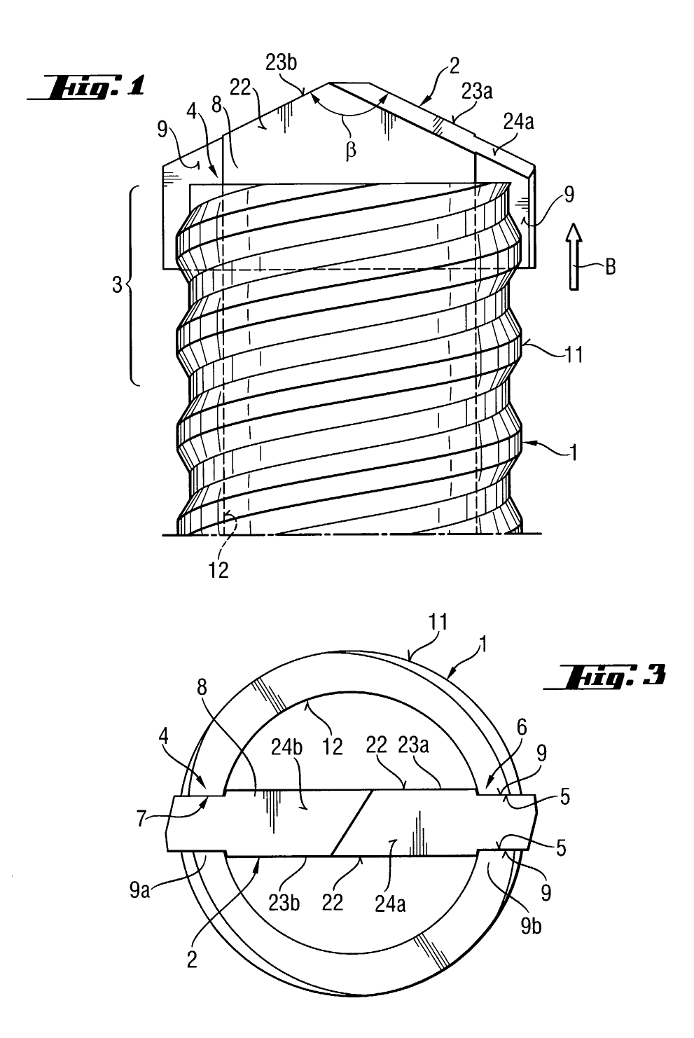

A drilling head according to the present invention, which is shown in FIGS. 1-5, has a base body 1 and a bit 2 that is secured in the base body 1 at the end of the base body 1 facing in a drilling direction of the drilling head. The clamping means 4, which provides for securing the bit 2 in the base body 1, includes two opposite inclination surfaces 5 which form, in the base body 1 a recess 10 widening in the drilling direction, and opposite inclination surfaces 9 which are provided on the bit and which cooperate with respective inclination surfaces 5 of the base body. The clamping means 4 further includes guide means 6 for guiding the base body 1 and the bit 2. The guide means 6 includes a groove 7 formed in the base body 1 and an extending in the drilling direction, web 8 provided in the bit 2 and complementary to the groove 7. The groove 7 is located in the direction transverse to the drilling direction B, somewhat in the middle between two edge regions 9a and 9b likewise extending in the direction transverse to the drilling direction.

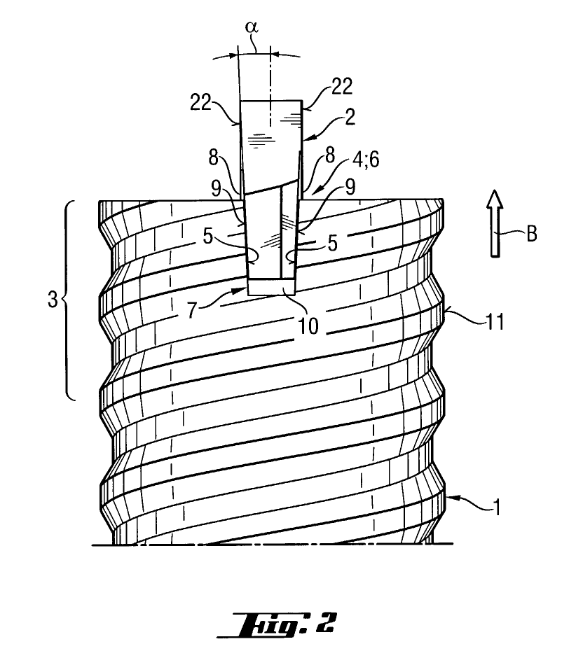

The inclination surfaces 5 and 9 have, in the direction opposite the drilling direction opposite the drilling direction, an angle α of 2.5° that opens in the drilling direction, as it can be seen particularly clear in FIG. 2. In the direction transverse to the drilling direction, the inclination surfaces 5, 9 have a side b that corresponds to 0.15 of the total width c of the bit 2 in the direction transverse to the drilling direction B as can be clearly seen in FIGS. 3 and 5.

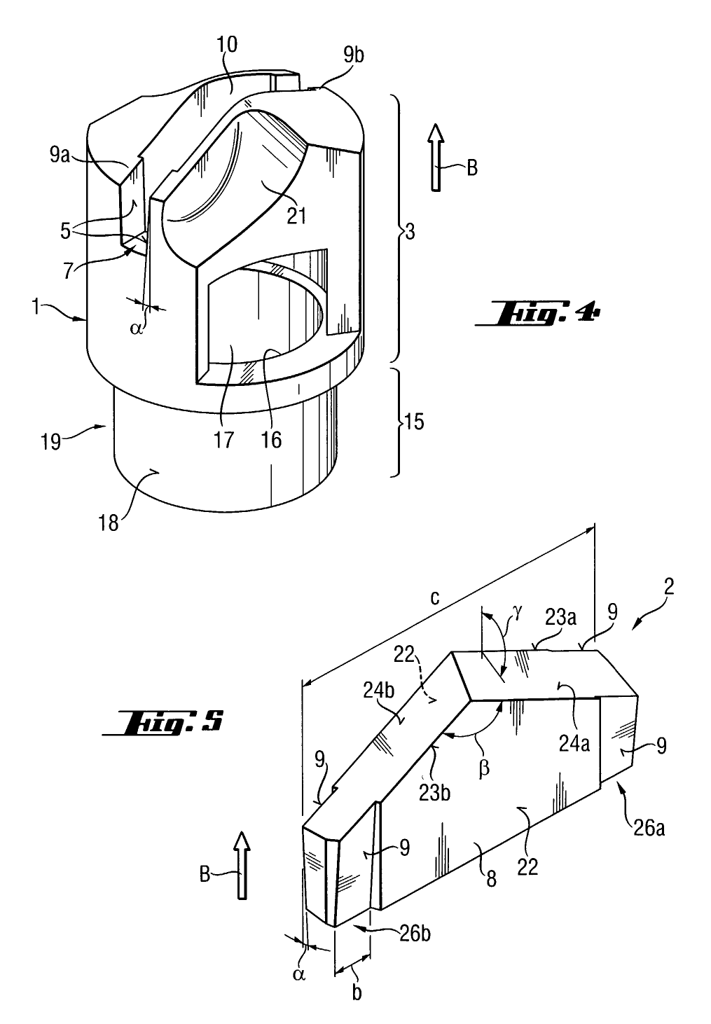

The first embodiment of the inventive drilling head, which is shown in FIGS. 1-3, and the second embodiment of the inventive drilling head, which is shown in FIGS. 4-5, have differently formed base bodies 1 but the same bit 2 that is shown in FIG. 5.

The bit 2 has substantially triangular side surfaces 22. The two legs of the bit 2, which form abase angle β if 130°, form cutting edges 23a, 23b of the bit 2. The cutting edges 23a, 23b limit each side 22 and are connected with the opposite side 22 by two surfaces 24a, 24b which form therebetween an inclination angle γ of 105°. The inclination surfaces 9 are formed by edge regions 26a, 26b of the sides 22. The edge regions 26a, 26b are separated from each other by the web 8.

The drilling head, which is shown in FIGS. 1-3, has a sleeve-shaped based body 1 having a trapezoidal outer profile 11. The inner wall 12 of the base body 1 has a cylindrical profile along the entire length of the base body 1 and forms, in the contact region between the inner wall 12 and the bit 2, the groove 7. As it has already been discussed above, the recess 1, which is formed by inclination surfaces 5, serves for receiving the bit 2, as shown particularly clear in FIGS. 2-3.

In the embodiment of the drilling head shown in FIG. 4, the base body 1 has a drilling direction side, substantially cylindrical, end region 3 and in the direction opposite to the drilling direction, a sleeve shape which is defined by a bore 16. The bore 16 is connected with the drilling direction side, end region 3 by a channel 17. The channel 17 could serve for removal of drillings produced during the drilling process. The outer surface 18 of the end region 15 has, at least at its end remote from the end region 3, a reduced diameter region 19 having a substantially cylindrical or conical profile. The region 19 serves for connecting the drilling head with a shaft of a power drilling tool or some connection element.

At its drilling direction side, the end region 15 has a plurality of recesses 21 for removing drillings from the drilling direction end of the base body.

Though the present invention was shown and described with references to the preferred embodiments such are merely illustrative of the present invention and are not to be construed as a limitation thereof, and various modifications to the prevent invention will be apparent to those skilled in the art. It is, therefore, not intended that the prevent invention be limited to the disclosed embodiments or details thereof, and the present invention includes all of variations and/or alternative embodiments within the spirit and scope of the present invention as defined by the appended claims.

What is claimed is:

1. A drilling head, comprising a base body (1); a bit (2) securable in the base body (1) at an end (3) of the base body (1) facing in a drilling direction (B); and clamping means (4) for securing the bit (2) in the base body (1), the clamping means (4) including two opposite inclination surfaces (5) forming a recess (10) widening in the drilling direction (B) and in which the bit (2) is secured, and guide means (6) for guiding the base body (1) and the bit (2) relative to each other in a direction transverse to the drilling direction (B).

2. A drilling head according to claim 1, wherein the guide means (6) comprises a groove (7) formed in one of the base body (1) and the bit (2), and a web (8) extending in the drilling direction (B) complementary to the groove (7) and provided on another of the base body (1) and the bit (2).

3. A drilling head according to claim 2, wherein the groove (7) is arranged, in a direction transverse to the drilling direction (B), somewhat in a middle between edge regions (9a, 9b) likewise extending in the direction opposite the drilling direction (B).

4. A drilling head according to claim 1, wherein the clamping means (4) further includes further inclination surfaces (9) cooperating with the inclination surfaces (5) for securing the bit (2) in the base body (1), and wherein the inclination surfaces (5, 9) form, in the direction opposite the drilling direction (B), an angle (α) from 1.5° to 4° and which opens in the drilling direction (B).

5. A drilling head according to claim 4, wherein the inclination surfaces (5) and the further inclination surfaces (9) have, in the direction transverse to the drilling direction (B), a width (b) corresponding to from 0.1 to 0.2 of a width (c) of the bit (2) insured in the direction transverse to the drilling direction.

6. A drilling head according to claim 1, wherein the base body (1) has a sleeve shape at least in a drilling direction side region thereof.

7. A drilling head according to the claim 6, wherein the groove (7) is formed by an inner wall (12) of the base body (1).
